(19) United States
(12) Patent Application Publication
(10) Pub. No.: US 2010/0208494 A1
(43) Pub. Date: Aug. 19, 2010

(54) Light Guiding Device and Thin Display Comprising the Same

(75) Inventors: Han-Ping Kuo, Hsinchu (TW); Cheng-Yi Su, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/696,271

(22) Filed: Jan. 29, 2010

(30) Foreign Application Priority Data
Feb. 17, 2009 (TW) 98104945

(51) Int. Cl. F21V 8/00; F21K 99/00

(52) U.S. Cl. 362/612; 362/257; 362/628; 362/611

(57) ABSTRACT

A light guiding device and a thin display comprising the same are disclosed. The thin display comprises a light guiding device, a panel, and a frame. The frame comprises two arc-shaped frames opposite each other and two side frames opposite each other. The light guiding device comprises a light guiding plate and a light source device. The light guiding plate comprises an upper curve surface, a lower curve surface, a first arc-shaped plane, and a second arc-shaped plane. Two edges of each of the upper and the lower curve surfaces are connected with the first arc-shaped plane and the second arc-shaped plane respectively. The light source device is disposed between one of the first and the second arc-shaped planes and one of two arc-shaped frames. The panel is disposed in the frame and above the light guiding device.

This application claims the benefit from the priority of Taiwan Patent Application No. 098104945 filed on Feb. 17, 2009, the disclosure of which is incorporated by reference herein in their entirety.

### CROSS-REFERENCES TO RELATED APPLICATIONS

Not applicable.

### BACKGROUND OF THE INVENTION

1. Field of the Invention

The present invention relates to a display, and more particularly, to an arc-shaped display.

2. Descriptions of the Related Art

Liquid crystal displays (LCDs) have gradually replaced conventional cathode ray tube (CRT) displays due to its advantages such as a low profile, light weight, low power consumption and low radiation.

Currently, LCDs generally have an upright outline. When a user fixates on such an LCD from above the display for a long time, visual fatigue tends to result. In view of this, LCDs with arc-shaped surfaces have been designed by some manufacturers to improve this problem.

FIG. 1 shows an arc-shaped display 1, which has two opposite sides 11, 12 and two opposite arc-shaped planes 13, 14. In the prior art arc-shaped display 1, a plurality of light emitting diodes (LEDs) 103 is disposed along either of the two opposite sides 11, 12, for example, on the side 11. However, a problem with such an arc-shaped display 1 is that light from LEDs 103 disposed along the side 11 can only propagate linearly instead of taking turns to follow the arc curvature of a light guiding plate. This leads to nonuniformity in the distribution of light on the light guiding plate, thereby resulting in light leakage at large angles.

Additionally, a solution of the prior art has attempted to additionally arrange a row of light source devices at the side where the luminance is insufficient (e.g., an end edge of the side 12 in FIG. 1) to increase the amount of light distributed at this side. However, it is difficult to integrate the two different light sources in this solution.

Accordingly, efforts still have to be made by manufacturers to solve the problem of light source arrangement on LCDs with an arc-shaped surface.

### SUMMARY OF THE INVENTION

One objective of the present invention is to provide a light guiding device adapted for a thin display. The light guiding device comprises a light guiding plate and a light source device. The light guiding plate has an upper curve surface, a lower curve surface, a first arc-shaped plane, and a second arc-shaped plane. Two edges of each of the upper curve surface and the lower curve surface are connected with the first arc-shaped plane and the second arc-shaped plane respectively. The light source device is disposed along one of the two arc-shaped planes.

Another objective of the present invention is to provide a thin display, which comprises a frame, a light guiding device and a panel. The frame has two opposite arc-shaped frames and two opposite side frames that are joined together. The light guiding device has a light guiding plate and a light source device. The light guiding plate comprises an upper curve surface, a lower curve surface, a first arc-shaped plane and a second arc-shaped plane. Two edges of each of the upper curve surface and the lower curve surface are connected with the first arc-shaped plane and the second plane respectively, and the first arc-shaped plane and the second arc-shaped plane are disposed in the two arc-shaped frames respectively. The light source device is disposed between one of the two arc-shaped planes and one of the two arc-shaped frames. The panel is disposed in the frame above the light guiding device and adjacent to the upper curve surface of the light guiding device.

By disposing the light source device along either of the two opposite arc-shaped planes, the light guiding device of the present invention overcomes the problem of light leakage caused by disposing the light source device on the two parallel sides in the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an arc-shaped display of the prior art,

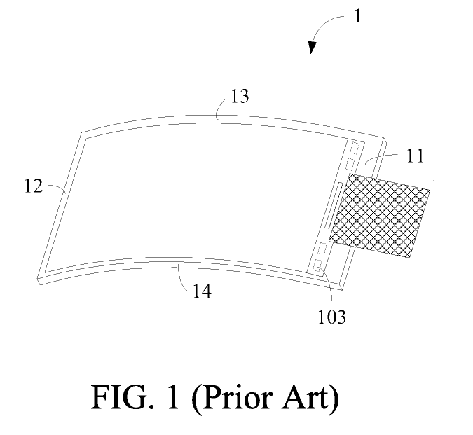

FIG. 2 is a schematic view of a thin display according to the first embodiment of the present invention; and

FIG. 3 is a schematic view of a thin display according to the second embodiment of the present invention.

### DESCRIPTION OF THE PREFERRED EMBODIMENT

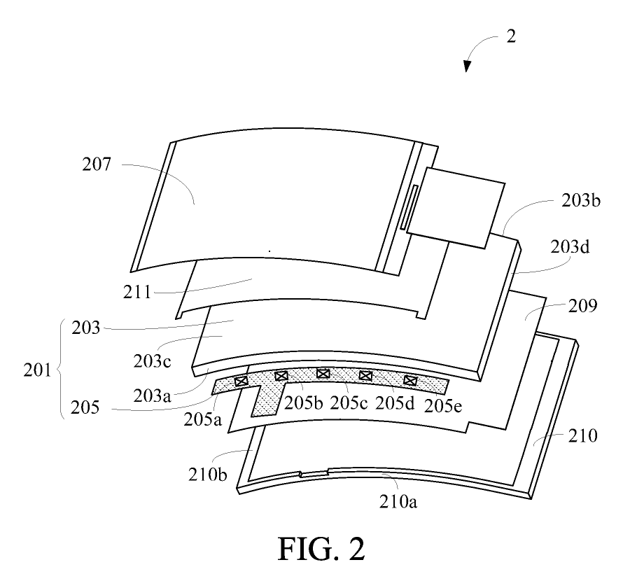

FIG. 2 illustrates a schematic view of a thin display 2 according to the first embodiment of the present invention. The thin display 2 comprises a light guiding device 201, a panel 207, a reflection film 209, a frame 210 and an optical thin film 211. The thin display 2 in this embodiment has an arc-shaped outline; however, the arc curvature shown in this figure is only for purposes of illustration but not to limit this invention.

The frame 210 has two opposite arc-shaped frames 210a and two opposite side frames 210b, and the arc-shaped frames 210a and the side frames 210b are joined together. The light guiding device 201 disposed in the frame 210 has a light guiding plate 203 and a light source device 205. The light guiding plate 203 comprises a first arc-shaped plane 203a, a second arc-shaped plane 203b, an upper curve surface 203c and a lower curve surface 203d. Two edges of each of the upper curve surface 203c and the lower curve surface 203d are connected with the first arc-shaped plane 203a and the second arc-shaped plane 203b respectively to form a three-dimensional arc-shaped light guiding plate. The first arc-shaped plane 203a and the second arc-shaped plane 203b are disposed in the two arc-shaped frames 210a respectively.

The present invention is characterized in that the light source device 205 is disposed between one of the two arc-shaped planes 203a, 203b and one of the two arc-shaped frames 210a. For example, in this embodiment, the light source device 205 is disposed between the first arc-shaped plane 203a and the arc-shaped frame 210a that is adjacent to the first arc-shaped plane 203a. In particular, in this embodiment, the light source device 205 of the light guiding device 201 comprises a light emitting diode (LED) module consisting of a plurality of LEDs as a light source, although the present invention is not limited thereto. The LEDs in the LED module of this embodiment are disposed along the first arc-shaped plane 203a and separated from each other at equal distances. For example, the LEDs 205a, 205b, 205c, 205d, 205e shown in FIG. 2 are disposed along the first arc-shaped plane 203a and separated from each other at equal distances to render the luminance of the whole display uniform, although this invention is not limited thereto.

In this embodiment, the first arc-shaped plane 203a and the second arc-shaped plane 203b of the light guiding plate 203 are parallel to each other. The upper curve surface 203c and the lower curve surface 203d have the same curvature between the two arc-shaped planes 203a, 203b, so light from the light source device 205 is adapted to advantageously propagate from the first arc-shaped plane 203a to the second arc-shaped plane 203b straightforwardly, thereby rendering the light distribution in the thin display 2 more uniform. In this way, the thin display 2 disclosed in the present invention overcomes the problem of nonuniform luminance distribution and light leakage of solutions in the prior art.

Additionally, the panel 207 of the thin display 2 is disposed above the light guiding device 201 and adjacent to the upper curve surface 203c of the light guiding device 201, the optical thin film 211 is disposed between the panel 207 and the light guiding device 201, and the reflection film 209 is disposed between the light guiding device 201 and the frame 210 to reflect the light generated by the light guiding device 201 and, thereby, improve the overall luminance of the panel 207. The optical structure of this part makes no substantial difference from that of the prior art, and thus will not be further described herein.

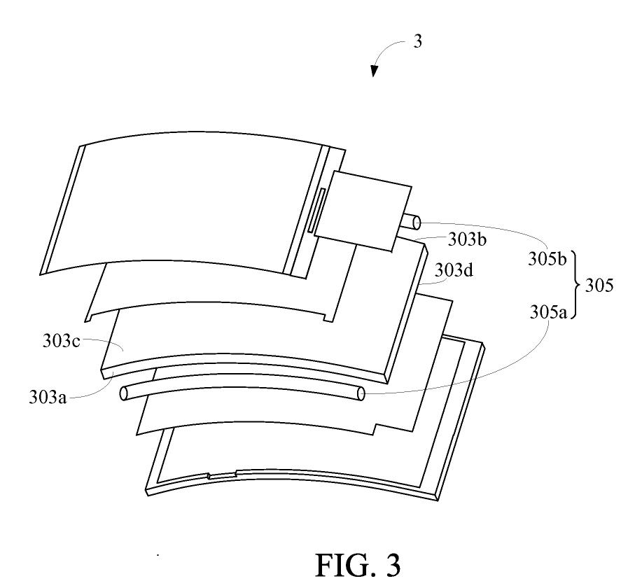

FIG. 3 is a schematic view of a thin display 3 according to the second embodiment of the present invention. The thin display 3 of this embodiment is generally the same as the previous embodiment, so identical portions will not be described again herein. This embodiment differs from the first embodiment in that the light source device 305 of this embodiment may comprise at least a first arc-shaped lamp 305a or a plurality of arc-shaped lamps (e.g., a first arc-shaped lamp 305a and a second arc-shaped lamp 305b) to replace the aforesaid LED module as the light source of the thin display 3. Hereinbelow, an example where the light source device comprises two arc-shaped lamps will be described. For example, the first arc-shaped lamp 305a is disposed along the first arc-shaped plane 303a, while the second arc-shaped lamp 305b is disposed along the second arc-shaped plane 303b. It should be noted that the arc-shaped lamps 305a and 305b in this embodiment have the same curvature as that of the upper curve surface 303c and the lower curve surface 303d, so the light emitted by the arc-shaped lamps 305a and 305b may also propagate from one of the arc-shaped planes to the other linearly and uniformly to present uniform luminance in the display. Thus, the problem of nonuniform luminance and light leakage of the prior art can also be overcome.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light guiding device, being adapted to a thin display, comprising:
a light guiding plate, having an upper curve surface, a lower curve surface, a first arc-shaped plane, and a second arc-shaped plane, two edges of each of the upper curve surface and the lower curve surface being connected with the first arc-shaped plane and the second arc-shaped plane respectively; and
a light source device disposed corresponding to one of the two arc-shaped planes.

2. The light guiding device of claim 1, wherein the first arc-shaped plane and the second arc-shaped plane are disposed parallel with each other.

3. The light guiding device of claim 1, wherein the upper curve surface and the lower curve surface comprise the same curvature.

4. The light guiding device of claim 1, wherein the light source device comprises at least one light emitting diode (LED).

5. The light guiding device of claim 1, wherein the light source device comprises at least one arc-shaped lamp.

6. A thin display, comprising:
a frame, having two opposite arc-shaped frames and two opposite side frames;
a light guiding device, being disposed in the frame, having:
a light guiding plate, comprising an upper curve surface, a lower curve surface, a first arc-shaped plane, and a second arc-shaped plane, two edges of each of the upper and the lower curve surface being connected with the first arc-shaped plane and the second plane respectively, and the first arc-shaped plane and the second arc-shaped plane being disposed in the two arc-shaped frames;
a light source device, being disposed between one of the two arc-shaped planes and one of the two arc-shaped frames; and
a panel, being disposed in the frame, above the light guiding device and neighboring to the upper curve surface of the light guiding device.

7. The thin display of claim 6, wherein the first arc-shaped plane and the second arc-shaped plane are disposed parallel with each other.

8. The thin display of claim 6, wherein the upper curve surface and the lower curve surface comprise the same curvature.

9. The thin display of claim 6, wherein the light source device comprises at least one light emitting diode.

10. The thin display of claim 6, wherein the light source device comprises at least one arc-shaped lamp.

11. The thin display of claim 6, further comprising a reflection film, being disposed between the frame and the light guiding device.

12. The thin display of claim 6, further comprising an optical thin film, being disposed between the panel and the light guiding device.
